(19) United States
(12) Patent Application Publication
(10) Pub. No.: US 2006/0294031 A1
(43) Pub. Date: Dec. 28, 2006

(54) Systems and methods for automated meter system

(75) Inventors: Kathleen A. Muller, Hilton, NY (US); Christian George Midgley, Fairport, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/165,050

(22) Filed: Jun. 24, 2005

(51) Int. Cl. G06F 17/00

(52) U.S. Cl. 705/404

(57) ABSTRACT

Systems and methods of automated meter system may include a processor, disposed at the device, that generates a report including data directed to an amount of usage of the device, identifying information of the device, identifying information of the user, and identifying information of the manager, and a transmitter that enables transmission of the report to the manager. Systems and methods may also include identifying informatics of a billing service, the report being generated and transmitted to the billing service to provide information to the billing service enabling the billing service to perform at least on of: bill the user an amount commensurate with the number of copies made by the user within the specified period, and determine whether the number of copies exceeds a specified maximum value.

### BACKGROUND

The present disclosure relates to systems and methods for an automated meter system. These systems and methods can be applied, for example, to a device that generates and transmits a report including data directed to an amount of usage of the device for billing purposes.

Various types of devices, such as, for example, a digital copier, can include a mechanism for computing amount of usage. The mechanism for computing the amount of usage can be a meter, and the amount of usage can be defined in terms of a meter count.

In the related art, the amount of usage (meter count) of such a device can be relevant to a business agreement between contracting parties. Such a business agreement can define the responsibilities of a customer (user, purchaser or lessee of the device) and a billing service (manufacturer, seller or lessor of the device). The business agreement can be a lease agreement or a purchase agreement for the device that includes billing periods for which the customer is required to make payments, and stipulated costs covering a predetermined amount of usage within a billing period, etc. The predetermined amount of usage within a billing period can be referred to as a meter allowance. The agreement can provide that if the customer exceeds the meter allowance, then the customer is billed for the amount of usage (meter count) that exceeds the meter allowance. In this case, the customer would only be billed for the difference between the amount of usage (meter count) and the meter allowance. Alternatively, the agreement can provide a stipulated cost per use (count) of the device. In this case, the customer would only be billed for the amount of usage (meter count) within the billing period.

The business agreement may provide that the billing service or the customer is responsible for collecting and reporting the amount of usage (meter count). In the related art, a representative for the billing service or the customer (representative) can manually retrieve the amount of usage (meter count) of the device by reading a display of the device. After reading the display, the representative can then submit the amount of usage (meter count) to the billing service either orally by telephone, by entering the amount of usage (meter count) onto an electronic form provided on a computer for electronic submission, or by entering the amount of usage (meter count) onto a hard copy document which can later be mailed, faxed, or scanned for electronic submission to the billing service.

### SUMMARY

It may be advantageous to automatically submit the amount of usage (meter count) of the device to the billing service electronically. One way to perform this automated submission is to connect the device and the billing service to a network. However, connection to a network may be logistically difficult because of the location of the respective devices, and may otherwise be disadvantageous for security reasons. Furthermore, some devices may not have the capability to electronically submit the amount of usage (meter count) to the billing service. In such a case, the representative manually retrieves the amount of usage (meter count) for submission to the billing service. In order to perform manual retrieval, the representative physically accesses each device to view the amount of usage (meter count) on a display (otherwise known as a user interface) of the device. After viewing the amount of usage (meter count), the representative must accurately record it for submission to the billing service.

This process is labor intensive because the representative must physically access each device. This process is also prone to errors due to the manual nature of memorizing, recording and submitting the amount of usage (meter count) to the billing service. In fact, the representative may have at least two opportunities to incorrectly record the amount of usage (meter count). First, the representative may erroneously record the amount of usage (meter count) after viewing it on the display of the device. Second, the representative may erroneously submit the amount of usage (meter count) to the billing service even if it was recorded accurately in the first place. Further, the representative may submit the amount of usage for an incorrect device. For example, the representative may erroneously identify the device when initially recording the amount of usage and/or submit the amount of usage for the incorrect device even if the device was recorded accurately in the first place.

Exemplary embodiments of an automated meter system for a device and the related methods may include a processor, disposed at the device, that generates a report including data directed to an amount of usage of the device, identifying information of the device, identifying information of the user, and identifying information of the manager; and a transmitter that enables transmission of the report to the manager.

By disposing a processor at the device, the device does not need to be connected to a network. By including a processor that generates a report and a transmitter that enables transmission of the report, the steps needed to collect the amount of usage (meter count) are reduced. The representative does not need to manually collect the amount of usage (meter count) of the device by viewing the display of the device, and correctly identify the device, in order to report the amount of usage (meter count) to the billing service. By generating the report without human intervention, accuracy is increased and the time required to generate the report is reduced. As a result, both the customer and billing service greatly increase productivity and profitability through increased billing accuracy, simplified customer experience and improved work process.

Exemplary embodiments may include a processor that generates the report such that the amount of usage is a count value indicating an amount of use of the device made by the user within a specified period. Identifying information of the manger may be identifying information of a billing service. The report may be generated and transmitted to the billing service to provide information to the billing service, enabling the billing service to perform at least one of: billing the user an amount commensurate with the amount of usage within the specified period, and determining whether the amount of usage exceeds a specified maximum value.

By generating a report such that the amount of usage (meter count) is a count value indicating an amount of use of the device made by the user within a specified period, the representative does not need to manually collect the amount of usage of the device by viewing the display device in order to report the amount of usage to the billing service. By generating the report to include the amount of usage (meter count) without human intervention, accuracy is increased and the time required to generate the report is reduced.

Exemplary embodiments may include may include a device that is at least one of a digital xerographic device, a facsimile device, a printing device, and a scan device. The processor may generate a report such that the amount of usage is a count value indicating at least one of a number of copies, number of fax transmissions, number of scans, and weight of toner made by the user within a specified period. The report may also include identifying information of a billing service. The report being generated and transmitted to the billing service may provide information to the billing service enabling the billing service to perform at least one of: billing the user an amount commensurate with the amount of usage within the specified period, and determining whether the amount of usage exceeds a specified maximum value.

By generating a report such that the amount of usage (meter count) is a count value indicating an amount of use of the device made by the user within a specified period, the representative does not need to manually collect the amount of usage of the device by viewing the display device in order to report the amount of usage to the billing service. By generating the report to include the amount of usage (meter count) without human intervention, accuracy is increased and the time required to generate the report is reduced. By generating a report with the identifying information of the billing service, the steps needed for transmission are reduced. By including the information on the report that enables the billing service to either bill the amount of usage (meter count) or determine whether the number of copies exceeds a specified maximum value (meter allowance), the representative does not need to tailor the report according to the business agreement between the customer and billing service. As a result, the customer experience is simplified and the work process for both the customer and billing service is improved.

Exemplary embodiments may include a processor that is a microprocessor and a local user interface, and a transmitter that is a printing device that prints the report. The printing device may print the report in a form that enables the transmission of the printed report to the manager by at least one of mail and facsimile. The printing device may also print the report in a form that enables the transmission of the printed report to the manager by electronic communication, whereby the printed report is scanned using a scan-enabled machine on a network of the user.

By printing a report that can be transmitted to the billing service by mail, by facsimile or by electronic communication using a scan-enabled machine, the representative has flexibility in transmitting the report. As a result, the customer experience is simplified and the work process for both the customer and billing service is improved.

Exemplary embodiments may include a user network or a manager network that further includes an application that monitors the amount of usage (meter count) of at least the device, whereby the printed report is scanned into the application to capture the data of the printed report, before transmitting the report to the manager through electronic communication or after transmitting the report to the manger.

By generating a report that can be scanned into an application to capture the printed report, the customer can track the amount of usage (meter count) of the device prior to transmitting the report to the billing service. The billing service can also track the amount of usage of the device after transmitting the report by scanning a report into an application. This system may also be used with systems already provided on network devices, thus allowing the customer and billing service to monitor the amount of usage (meter count) for devices using this system and devices that may automatically transmit the amount of usage (meter count). As a result, the customer experience is simplified and the work process for both the customer and billing service is improved.

Exemplary embodiments may include a report including a machine readable identifier that identifies at least one of the user of the device and the device, such that the report is scanned by the manager or the user, whereby the machine readable identifier enables automatic recognition of the device and the user of the device.

By generating a report with a machine readable identifier, for example, such as a bar code or text, the billing service can automate the collection of the amount of usage (meter count) of the device from the scanned report. This maximizes character recognition. As a result, the machine readable identifier helps to simplify the work process as well as increase the productivity of the billing service.

Exemplary embodiments may include a transmitter that is a mobile device that enables transmission of the report to the manager by wireless communication, the report being transmitted electronically from the device to the mobile device.

By enabling transmission of the report to the manager by wireless communication, a representative can electronically capture the report for immediate transmission. As a result, the customer experience is simplified and the work process for both the customer and billing service is improved.

Although this system and method are particularly advantageous when applied to a device that is not connected to a network, they can also be applied to a device that is connected to a network.

### BRIEF DESCRIPTION OF THE DRAWINGS

Various exemplary details are described herein, with reference to the following figures, wherein:

FIG. 1 is a block diagram outlining an exemplary system for an automated billing system;

FIG. 2 is a flowchart outlining an exemplary method of generating and transmitting a report;

FIG. 3 is a flowchart outlining an exemplary method of generating a printed report;

FIG. 4 is a flowchart outlining an exemplary method of transmitting a printed report by mail;

FIG. 5 is a flowchart outlining an exemplary method of transmitting a printed report by facsimile;

FIG. 6 is a flowchart outlining an exemplary method of transmitting a printed report by a electronic communication application;

FIG. 7 is a flowchart outlining an exemplary method of transmitting a printed report by device management application; and

FIG. 8 is a flowchart outlining an exemplary method of electronically transmitting a report.

FIG. 9 is a flowchart outlining an exemplary method of electronically capturing the report after transmission.

### DETAILED DESCRIPTION OF EMBODIMENTS

However, it should be appreciated that the description of exemplary embodiments is for ease of understanding and familiarity only, and does not exclude other types of image forming apparatus, whether known or later developed.

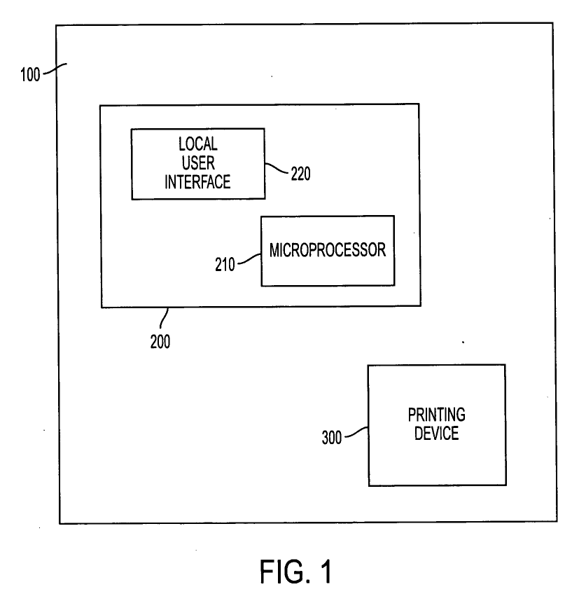

FIG. 1 is a block diagram outlining an exemplary automated meter system, such as system for automated billing for a device 100. The device 100 may be, for example, a digital photocopier, xerographic device, or any other device amenable to an automated meter system. The device 100 may be connected to a network or not connected to a network. As shown in FIG. 1, the exemplary system includes a processor 200 for generating a report. The processor 200 may include a microprocessor 210 and local user interface 220. The device 100 may further include a transmitter for generating the report. The transmitter may include a printing device 300. However, the transmitter does not have to be part of the device 100.

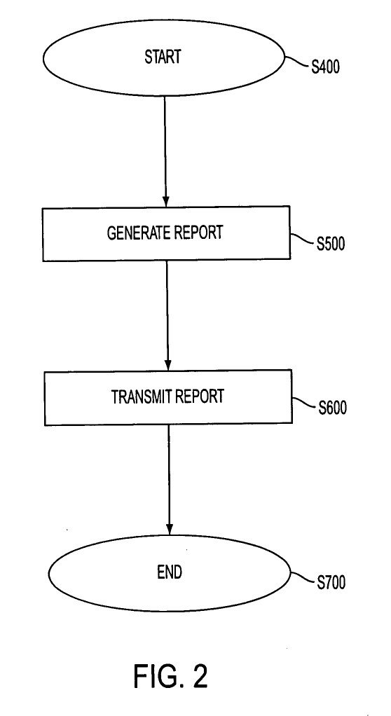

FIG. 2 shows a flowchart outlining an exemplary method of the automated billing system. As shown in FIG. 2, operation of the method begins in step S400 and continues to step S500, where a report is generated.

A report generated by the automated billing system may be, for example, a one-page document. One side of the report may include, for example, identifying information of the device, such as a serial number; identifying information of the user, such as a customer account number; an amount of usage, such as a meter count; and a machine readable identifier, such as a bar code. The report may also include information on the opposite side, for example, the identifying information of the manager, such as a mailing address of the billing service. Although the report may not be a hard copy, the information may be generated for electronic transmission.

After the report is generated as shown at step S500 of FIG. 2, the report is transmitted to the billing service, such as the manufacturer of the device, as shown at step S600. After transmitting the report, as shown at step S600, the customer or service representative has satisfied the business agreement for that billing period by collecting and submitting the amount of usage (meter count) to the billing service.

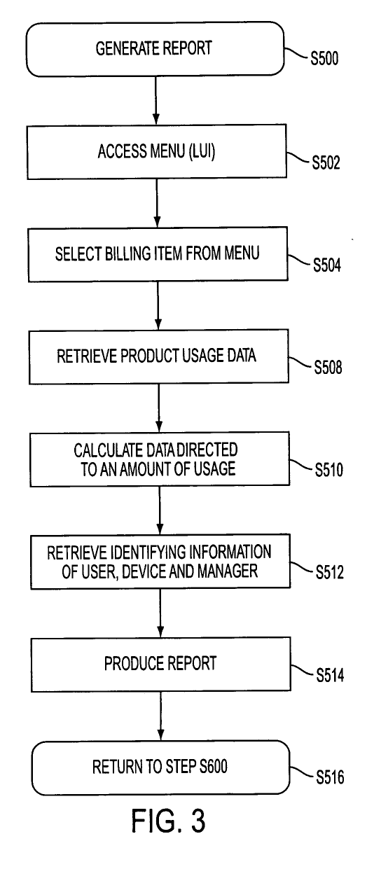

FIG. 3 is a flowchart outlining in greater detail the exemplary method of generating a report. As shown at step S502, a representative accesses a local user interface (menu) of the device. The representative then selects a feature to generate a report on the menu of the device, as shown at step S504. The microprocessor retrieves the product usage data, as shown at step S508, and calculates data directed to the amount of usage (meter count), as shown at step S510. The microprocessor then retrieves identifying information stored in the device, for example, such as a serial number of the device, a customer account number, a bar code, and a mailing address of the billing service, as shown at step 512. After retrieving the identifying information, the processor generates the report, as shown at step S514. The report is then ready for transmission, as shown at step S516 and is transmitted, as shown at step S600 (FIG. 2).

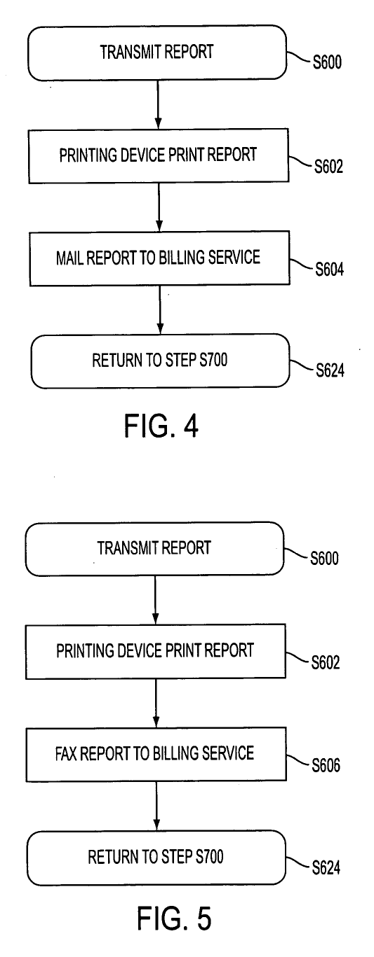

FIG. 4 shows a flowchart outlining in greater detail the exemplary method of transmitting a hard copy of the report to the billing service by mail. After the report is generated, as shown at step S500, the printing device prints a report, as shown at step S602. As shown at step S604, the representative can then mail the report to the billing service through a local mail carrier.

FIG. 5 shows a flowchart outlining in greater detail an alternative exemplary method of transmitting a hard copy of the report to the billing service by facsimile. After the report is generated, as shown at step S500 of FIG. 2, the device prints a report, as shown at step S602. As shown at step S606, the representative can directly transmit the report by facsimile to the billing service.

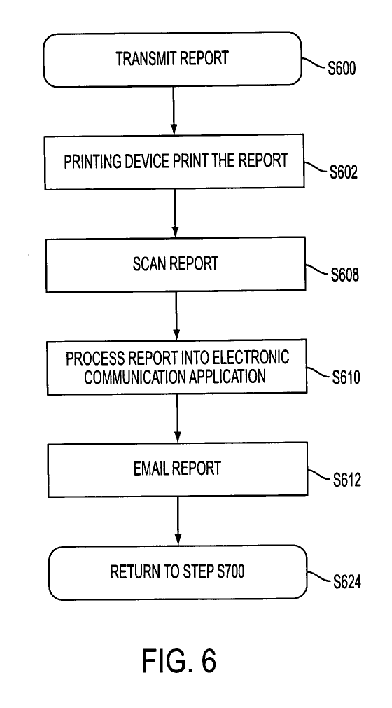

FIG. 6 shows a flowchart outlining in greater detail an alternative exemplary method of electronically transmitting a hard copy of the report. After the report is generated, as shown at step S500 of FIG. 2, the device prints a report, as shown at step S602. In step S608, the representative can scan the report using a scan-enabled machine that is connected to a network. In step S610, the representative can process the scanned report into an application for electronic communication. After scanning the report, the representative can then transmit the report to the billing service by electronic mail to the billing service, as shown at step S612.

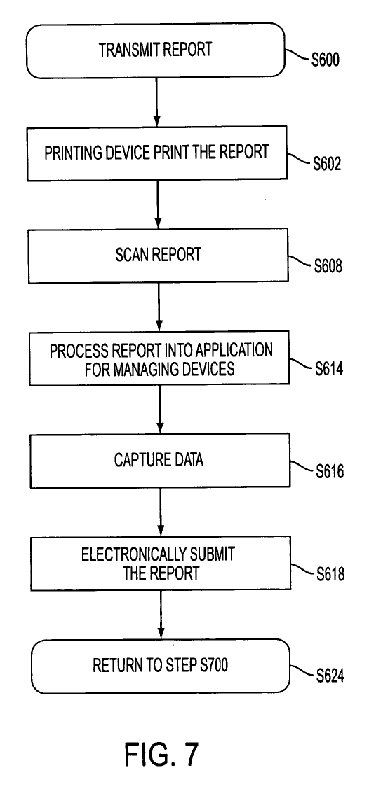

FIG. 7 shows a flowchart outlining in greater detail an alternative exemplary method of electronically transmitting a hard copy of the report. After the report is generated, as shown at step S500 of FIG. 2, the device prints a report in step S602. As shown at step S608, the representative can scan the report using a scan-enabled machine that is connected to a network. As shown at step S614, the representative can process the scanned report into an application for managing the customer's devices. As shown at step S616, the representative can capture the data contained in the report into the application. After capturing the data contained in the report, the representative can then transmit the report to the billing service electronically, as shown at step S618.

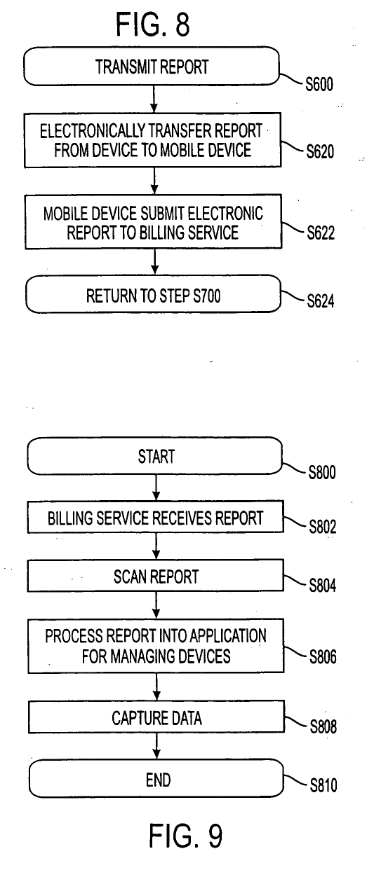

FIG. 8 shows a flowchart outlining in greater detail an alternative exemplary method of transmitting the report electronically. After the report is generated, as shown at step S500 of FIG. 2, the representative can electronically transfer the report to a mobile device, such as personal data assistant, for example, as shown at step S620. After transferring the device to the mobile device, the mobile device can then electronically submit the report to the billing service, as shown at step S622.

FIG. 9 shows a flowchart outlining an exemplary method of electronically capturing the information of the report. After the report is transmitted to the billing service by, for example, mail, facsimile, scanning, or electronically, as shown at step S802, the billing service can scan the report using a scan enabled machine that is connected to a network, as shown at step S804. As shown at step S806, the representative can process the scanned report into an application for managing the billing service's devices. As shown at step S808, the representative can capture the data contained in the report into the application.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. An automated meter system for a device, the device being used by a user and managed by a manager, the system comprising:
a processor, disposed at the device, that generates a report including data directed to an amount of usage of the device, identifying information of the device, identifying information of the user, and identifying information of the manager; and
a transmitter that enables transmission of the report to the manager.

2. The automated meter system according to claim 1, wherein:
the processor generates the report such that the amount of usage is a count value indicating an amount of use of the device made by the user within a specified period, and
the identifying information of the manger is identifying information of a billing service, the report being generated and transmitted to the billing service to provide information to the billing service enabling the billing service to perform at least one of: bill the user an amount commensurate with the amount of usage within the specified period, and determine whether the amount of usage exceeds a specified maximum value.

3. The automated meter system according to claim 2, wherein:
the device is at least one of a digital xerographic device, a facsimile device, a printing device, and a scan device,
the amount of usage is a count value indicating at least one of number of copies made, number of fax transmissions sent, number of scans transmitted, and weight of toner used by the user.

4. The automated meter system according to claim 1, wherein the processor includes a microprocessor and a local user interface, and the transmitter is a printing device that prints the report.

5. The automated meter system according to claim 4, wherein the printing device prints the report in a form that enables the transmission of the printed report to the manager by at least one of mail and facsimile.

6. The automated meter system according to claim 4, wherein the printing device prints the report in a form that enables the transmission of the printed report to the manager by electronic communication, whereby the printed report is scanned using a scan-enabled machine on a network of the user.

7. The automated meter system according to claim 6, wherein the network of the user or a network of the manager further includes an application that monitors the amount of usage of at least the device, whereby the user can scan the printed report into the application to capture the data of the printed report, before transmitting the report to the manager through electronic communication or after transmitting the report to the manager.

8. The automated meter system according to claim 1, wherein the report further includes a machine readable identifier that identifies at least one of the user of the device and the device, such that the report can be scanned by the manager or the user, whereby the machine readable identifier enables automatic recognition of the device and the user of the device.

9. The automated meter system according to claim 1, wherein the transmitter is a mobile device that enables transmission of the report to the manager by wireless communication, the report being transmitted electronically from the device to the mobile device.

10. A method for an automated meter system for a device, the device being used by a user and managed by a manager, comprising:
generating a report that includes data directed to an amount of usage of the device by an user, identifying information of the device, identifying information of the user and identifying information of a manager; and
transmitting the report to the manager.

11. The method for an automated meter system according to claim 10, wherein the device is a digital xerographic device, and the amount of usage is a count value indicating a number of copies made by the user within a specified period.

12. The method for an automated meter system according to claim 11, wherein:
the processor generates the report such that the amount of usage is a count value indicating an amount of use of the device made by the user within a specified period, and
the identifying information of the manger is identifying information of a billing service, the report being generated and transmitted to the billing service to provide information to the billing service enabling the billing service to perform at least one of: bill the user an amount commensurate with the amount of usage within the specified period, and determine whether the amount of usage exceeds a specified maximum value.

13. The method for an automated meter system according to claim 12, wherein:
the device is at least one of a digital xerographic device, a facsimile device, a printing device, and a scan device,
the amount of usage is a count value indicating at least one of number of copies made, number of fax transmissions sent, number of scans transmitted, and weight of toner used by the user.

14. The method for an automated meter system according to claim 13, wherein the printing the report includes printing the report in a form that enables the transmission of the printed report to the manager by at least one of mail and facsimile.

15. The method for an automated meter system according to claim 13, wherein printing the report includes printing the report in a form that enables the transmission of the printed report to the manager by electronic communication, whereby the printed report is scanned using a scan-enabled machine on a network of the user.

16. The method for an automated meter system according to claim 15, wherein the network of the user or a network of the manager further includes an application that monitors the amount of usage of at least the device, whereby the user can scan the printed report into the application to capture the data of the printed report, before transmitting the report to the manager by electronic communication or after transmitting the report to the manager.

17. The method for an automated meter system according to claim 10, wherein the report further includes a machine readable identifier that identifies at least one of the user of the device and the device, such that the report can be scanned by the manager or the user, whereby the machine readable identifier enables automatic recognition of the device and the user of the device.

18. The method for an automated meter system according to claim 10, wherein the transmitting includes transmitting the report with a mobile device, the mobile device enabling transmission of the report to the manager by wireless communication, the report being transmitted electronically from the device to the mobile device.

19. An automated meter system for a device, the device being used by a user and managed by a manager, the system comprising:
means for generating a report, that is disposed at the device, the report including data directed to an amount of usage of the device, identifying information of the device, identifying information of the user, and identifying information of the manager; and
means for transmitting the report to the manager of the device.

20. A xerographic device comprising the system of claim 1.
